(19) United States
(12) Patent Application Publication
(10) Pub. No.: US 2010/0328947 A1
(43) Pub. Date: Dec. 30, 2010

(54) LIGHT-EMITTING DIODE LIGHT SOURCE ASSEMBLY WITH HEAT DISSIPATION BASE

(75) Inventors: Chung-Min Chang, Jhubei City (TW); Yung-Chi Huang, Jhubei City (TW)

Correspondence Address: STITES & HARBISON PLLC, Suite 900, 1199 N. Fairfax Street, Alexandria, VA, 22314, US

(73) Assignee: Power Light Tech. Co., Ltd., Jhubei City (TW)

(21) Appl. No.: 12/545,223

(22) Filed: Aug. 21, 2009

(30) Foreign Application Priority Data
Jun. 30, 2009 (TW) 098121998

(51) Int. Cl. F21S 4/00; F21V 29/00

(52) U.S. Cl. 362/249.02; 362/294

(57) ABSTRACT

A light-emitting diode (LED) light source assembly with a heat dissipation base is provided. The LED light source assembly includes the heat dissipation base and a light bar. The light bar includes a flexible printed circuit (FPC) board and at least one LED unit which is disposed on the FPC board and electrically connected to the FPC board. The heat dissipation base has two retaining recesses for lodging the side portions of the FPC board, so the FPC board can be thermally conductively connected to the heat dissipation base. Because of the flexibility of the FPC board, it is easy to lodge the FPC board in the heat dissipation base via the retaining recesses. Thus, the cost for arranging the light bar can be economized.

### BACKGROUND OF THE INVENTION

1. Technical Field

The present invention relates to a light-emitting diode (LED) light source assembly with a heat dissipation base. More particularly, the present invention relates to an LED light source assembly including a heat dissipation base and a flexible printed circuit (FPC) board.

2. Description of Related Art

Generally, an LED light source assembly includes LED units soldered to an FR4 substrate or an aluminum substrate with surface-mount technology (SMT). In addition, a heat dissipation mechanism is provided at a rear side of the FR4 substrate or the aluminum substrate so as for heat generated by the LED units to be dissipated via the heat dissipation mechanism. However, the heat dissipation mechanism must be secured in position to the FR4 substrate or the aluminum substrate by means of screws or adhesive. If screws are used to fasten the FR4 substrate or the aluminum substrate to the heat dissipation mechanism, the drilling and tapping processes, as well as the screws themselves, will incur additional costs. If adhesive is used instead, as the LED units project light downward and are also heat-generating elements, heat generated by the LED units may cause the adhesive to deteriorate. Consequently, the FR4 substrate or the aluminum substrate may peel off or be otherwise detached from the heat dissipation mechanism, resulting in failure of the LED light source assembly.

In order to solve the aforesaid problem of coupling the substrate with the heat dissipation mechanism, Taiwan Patent No. M324216 provides an LED backlight module comprising a metal supporting element, a heat conducting material, a circuit board, and at least one LED unit. The metal supporting element has a sunken part. The heat conducting material has a surface in contact with a bottom surface of the sunken part of the metal supporting element. The circuit board is disposed on an opposite surface of the heat conducting material. The circuit board is formed with flanges or resilient fasteners to be lodged in a plurality of holes of the metal supporting element, respectively, such that the circuit board, the heat conducting material, and the metal supporting element are closely coupled together. As the LED units are arranged on the circuit board, heat generated by the LED units is transferred through the circuit board and the heat conducting material to the metal supporting element and thereby dissipated.

According to the disclosure of the above-cited Taiwan patent, the circuit board is coupled with the metal supporting element without using screws or adhesive. However, since the circuit board and the metal supporting element are both made of rigid materials, it is very difficult to insert the flanges or resilient fasteners of the circuit board into the holes of the metal supporting element. If the flanges or resilient fasteners are forced into engagement with the holes of the metal supporting element, the circuit board or the LED units may be damaged.

### BRIEF SUMMARY OF THE INVENTION

The present invention provides a light-emitting diode (LED) light source assembly with a heat dissipation base, wherein the heat dissipation base is formed with retaining recesses corresponding in shape to two side portions of a flexible printed circuit (FPC) board such that the two side portions of the FPC board can be secured in position in the retaining recesses. In other words, the FPC board can be installed without using screws or adhesive, thereby reducing processing cost as well as material and labor costs.

The present invention provides an LED light source assembly with a heat dissipation base, wherein an FPC board is used as a substrate for supporting at least one LED unit. In consequence, the flexibility of the FPC board facilitates installation of a light bar composed of the FPC board and the LED unit.

The present invention provides an LED light source assembly with a heat dissipation base, wherein the shape of an FPC board provided on the heat dissipation base conforms to the shape of a bottom surface of the heat dissipation base, thanks to the flexibility of the FPC board. Therefore, the light projection angle of LED units of the LED light source assembly can be adjusted by varying the shape of the bottom surface of the heat dissipation base, thereby achieving the predetermined optical design.

In order to attain the above and other effects, the present invention provides an LED light source assembly with a heat dissipation base, wherein the LED light source assembly includes a light bar in addition to the heat dissipation base. The heat dissipation base is formed with a groove having a bottom surface, a first lateral surface, and a second lateral surface, wherein the first lateral surface and the second lateral surface are provided respectively with corresponding retaining recesses. The light bar includes an FPC board and at least one LED unit. The FPC board is disposed on the bottom surface of the groove. The FPC board has two side portions lodged in the retaining recesses, respectively, thereby securing the FPC board in place. The at least one LED unit is disposed on and electrically connected to the FPC board. The retaining recesses correspond in shape to the two side portions of the FPC board so as to lodge the two side portions and fix the FPC board in position.

Implementation of the present invention at least involves the following inventive steps:

1. The FPC board is secured in position to the heat dissipation base by means of the retaining recesses which correspond in shape to the two side portions of the FPC board. Consequently, processing cost as well as material and labor costs can be minimized.

2. Due to the flexibility of the FPC board, the light bar can be arranged in the heat dissipation base with ease.

3. The light projection angle of the at least one LED unit can be adjusted by varying the shape of the bottom surface of the heat dissipation base, thus allowing the optical design of the light bar to meet predetermined goals.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawings, wherein:

FIG. 1 is an exploded perspective view of an LED light source assembly with a heat dissipation base according to the present invention;

FIG. 2 is an exploded sectional view of the LED light source assembly with the heat dissipation base according to the present invention;

FIG. 3 is an assembled sectional view of the LED light source assembly with the heat dissipation base according to the present invention;

FIG. 4 is a partial sectional view of the heat dissipation base according to the present invention;

FIG. 5 is a partial sectional view of a first embodiment of the LED light source assembly with the heat dissipation base according to the present invention;

FIG. 6 is a partial sectional view of a second embodiment of the LED light source assembly with the heat dissipation base according to the present invention;

FIG. 7A is a sectional view showing a first aspect of the LED light source assembly with the heat dissipation base according to the present invention;

FIG. 7B is a sectional view showing a second aspect of the LED light source assembly with the heat dissipation base according to the present invention; and

FIG. 8 is a sectional view showing a third aspect of the LED light source assembly with the heat dissipation base according to the present invention.

### DETAILED DESCRIPTION OF THE INVENTION

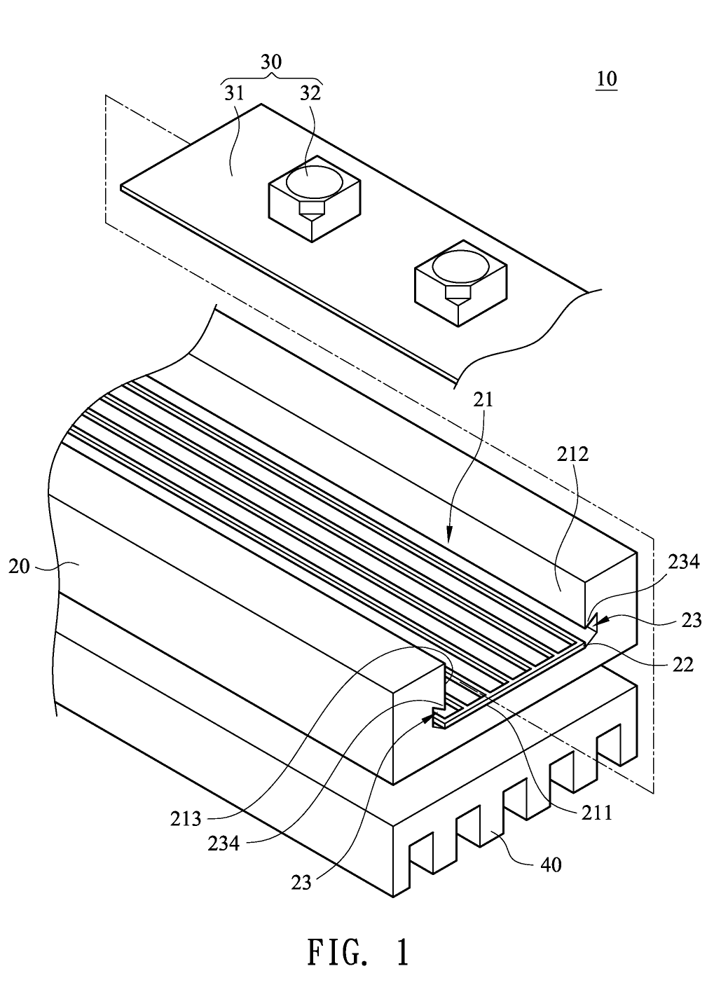

Referring to FIG. 1, according to an embodiment of the present invention, a light-emitting diode (LED) light source assembly 10 with a heat dissipation base 20 includes a light bar 30 in addition to the heat dissipation base 20.

As shown in FIG. 1, the heat dissipation base 20 is a base made of a metal with a high heat-dissipation coefficient. The heat dissipation base 20 is made of aluminum, copper, iron, stainless steel, or a composite metal with a layered structure. The heat dissipation base 20 has a groove 21 for receiving the light bar 30. The groove 21 has a bottom surface 211, a first lateral surface 212, and a second lateral surface 213 which together form a receiving space with an opening. As shown in FIG. 1, in order to provide an enhanced thermally conductive insulation effect between the light bar 30 and the heat dissipation base 20, the bottom surface 211 of the groove 21 is provided with a thermally conductive insulation layer 22 such that, when the light bar 30 is disposed on the heat dissipation base 20, heat generated by the light bar 30 can be dissipated rapidly through the thermally conductive insulation layer 22. The thermally conductive insulation layer 22 is a ceramic insulation layer or an aluminum nitride insulation layer.

Referring to FIG. 1 through FIG. 3, the first lateral surface 212 and the second lateral surface 213 of the groove 21 are formed respectively with retaining recesses 23 which correspond in position to each other. The retaining recesses 23 are located near the bottom surface 211 of the groove 21. In addition, the retaining recesses 23 correspond in shape to two side portions 312 of the light bar 30 so as to lodge the two side portions 312 and thereby secure the light bar 30 in position.

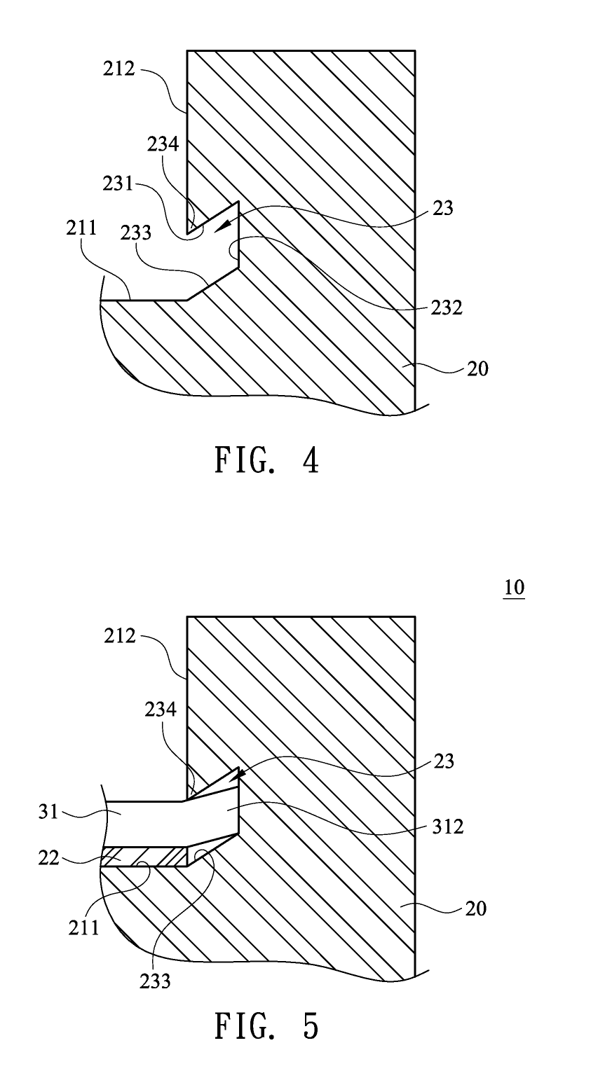

With reference to FIG. 4, each of the retaining recesses 23 has a first surface 231, a second surface 232, and a third surface 233.

As shown in FIG. 4, the first surface 231 of the retaining recess 23 is located at an upper edge portion of the retaining recess 23, wherein the upper edge portion is an edge portion adjacent to the first lateral surface 212. The retaining recess 23 further has a lower edge portion, which is an edge portion adjacent to the bottom surface 211 of the groove 21.

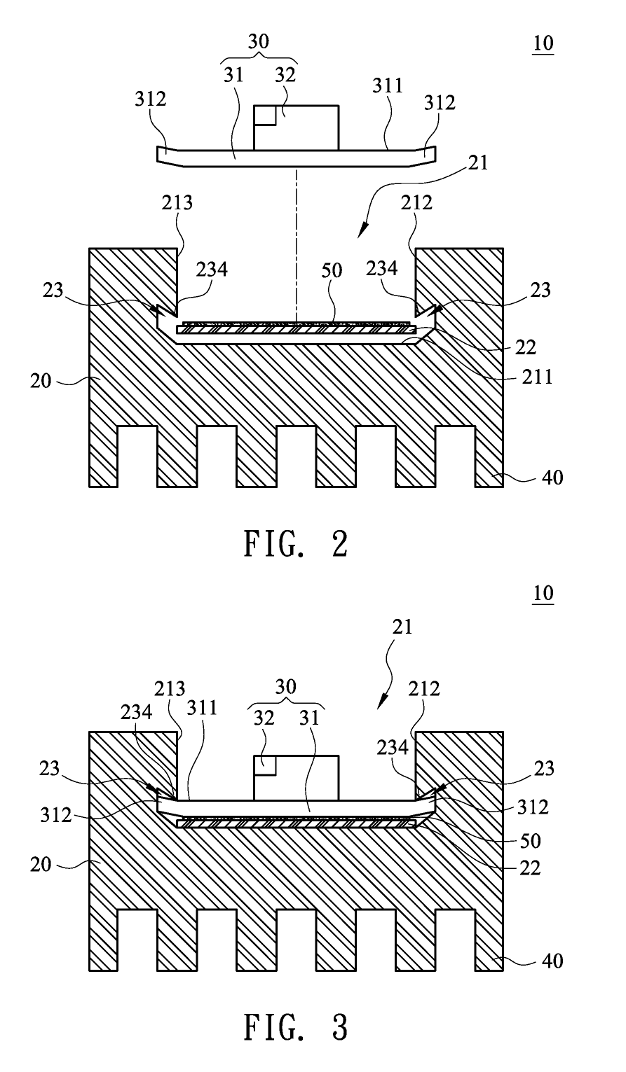

The first surface 231 of the retaining recess 23 and the first lateral surface 212 of the groove 21 jointly define an acute included angle, thereby forming a projecting retaining tip 234. Similarly, the second lateral surface 213 of the groove 21 is formed with the corresponding retaining recess 23. The retaining recess 23 at the second lateral surface 213 also has a first surface 231, and an acute included angle is similarly defined by this first surface 231 and the second lateral surface 213 so as to form a projecting retaining tip 234 (as shown in FIG. 2).

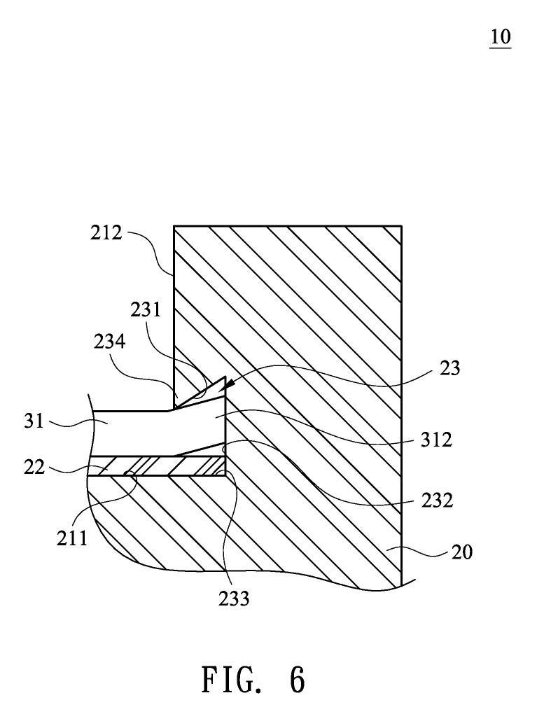

Referring to FIG. 4, for the retaining recess 23 at the first lateral surface 212, the second surface 232 adjoins the first surface 231 and is parallel to the first lateral surface 212. Referring to FIG. 2, the second surface 232 of the retaining recess 23 at the second lateral surface 213 is parallel to the second lateral surface 213. The third surface 233 is located at the lower edge portion of the retaining recess 23 and adjoins the corresponding second surface 232 and the bottom surface 211. The third surface 233 can be a horizontal surface (as shown in FIG. 6) or an inclined surface (as shown in FIG. 4 and FIG. 5), thus rendering the retaining recess 23 a horizontal recess (as shown in FIG. 6) or an inclined recess (as shown in FIG. 4 and FIG. 5).

With reference to FIG. 5 and FIG. 6, the retaining tip 234 of the retaining recess 23 serves to retain a corresponding one of the two side portions 312 of the light bar 30. Therefore, when the LED light source assembly 10 is turned upside down, the two side portions 312 of the light bar 30 are secured in position in the retaining recesses 23 and will not fall out of the retaining recesses 23.

Referring to FIG. 1, the light bar 30 includes a flexible printed circuit (FPC) board 31 and at least one LED unit 32.

The FPC board 31 is a copper foil FPC board. More particularly, the substrate of the FPC board 31 is made of polyimide (PI) or polyethylene terephthalate (PET) while the copper foil is laminated on the substrate and etched so as to form electrically conductive paths. The FPC board 31 has such advantages as flexibility, the ability to be curved and bent at will, small thickness and volume, easy connection, convenient detachment, and readiness for electromagnetic shielding solutions. Besides, the FPC board 31 has a surface 311 coated with a white reflective ink or a highly reflective ink so as to enhance reflection of light from the at least one LED unit 32, thereby increasing the efficiency of light emission.

As shown in FIG. 1, the FPC board 31 can be pushed into the groove 21 from an end of the heat dissipation base 20 so as to be disposed on the bottom surface 211 of the groove 21. Referring to FIG. 3, as the retaining recesses 23 correspond in shape to the two side portions 312 of the FPC board 31, the two side portions of the FPC board 31 can be lodged in the retaining recesses 23, respectively, thereby securing the FPC board 31 in place. Further, due to the flexibility of the FPC board 31, the FPC board 31 can be pushed into and then taken out of the groove 21 with ease, thus reducing the cost of installation, including processing cost as well as material and labor costs.

With reference to FIG. 1, the at least one LED unit 32 is disposed on the FPC board 31. More particularly, the LED units 32 are soldered to the FPC board 31 with surface-mount technology so as to be electrically connected to the FPC board 31. Optionally, a connector for power input is also soldered to the FPC board 31 with surface-mount technology.

To increase the efficiency of heat dissipation, referring to FIG. 1, heat dissipation fins 40 or heat conduction pipes (not shown) are further provided and are thermally conductively connected to the heat dissipation base 20. Thus, heat generated by the at least one LED unit 32 can be transferred through the FPC board 31, the thermally conductive insulation layer 22, and the heat dissipation base 20 to the heat dissipation fins 40 and then dissipated via the heat dissipation fins 40. Referring to FIG. 2 and FIG. 3, the heat dissipation base 20 is so shaped as to include the heat dissipation fins 40, thus lowering material cost and eliminating the step of installing the heat dissipation fins 40.

As shown in FIG. 2 and FIG. 3, a heat dissipation pad 50 or a heat dissipation gel 50 is provided between the FPC board 31 and the bottom surface 211 of the groove 21. More particularly, the heat dissipation pad 50 or the heat dissipation gel 50 is provided on the thermally conductive insulation layer 22 on the bottom surface 211, thereby enhancing thermal conductivity between the FPC board 31 and the heat dissipation base 20.

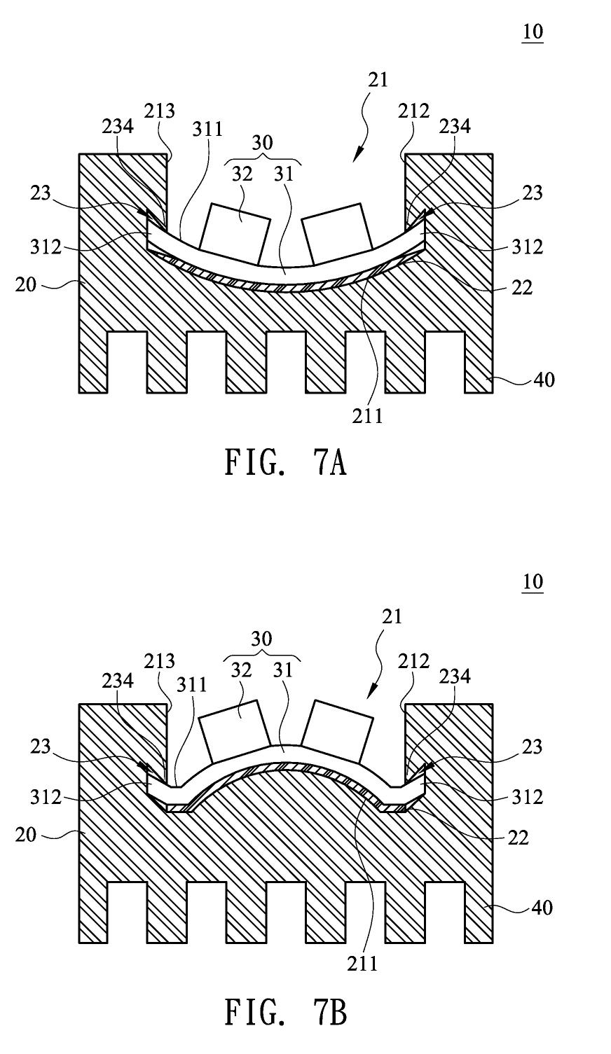

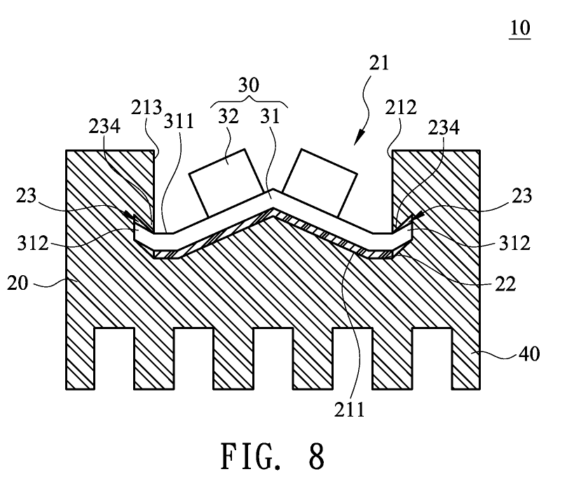

When the FPC board 31 is disposed on the bottom surface 211 of the groove 21, due to the flexibility of the FPC board 31, the shape of the FPC board 31 changes so as to conform to the shape of the bottom surface 211. For instance, the bottom surface 211 of the groove 21 can be a planar surface (as shown in FIG. 1), a concave surface (as shown in FIG. 7A), a convex surface (as shown in FIG. 7B), or a multi-sectional surface (as shown in FIG. 8). Accordingly, the shape of the FPC board 31 adapts to the shape of the bottom surface 211 and become planar (as shown in FIG. 1), concave (as shown in FIG. 7A), convex (as shown in FIG. 7B), or multi-sectional (as shown in FIG. 8).

Therefore, by changing the shape of the bottom surface 211 of the groove 21, the at least one LED unit 32 can be located at different positions so as to emit light from different angles. In other words, the light projection angle can be varied for achieving the predetermined optical design.

The foregoing embodiments are illustrative of the characteristics of the present invention so as to enable a person skilled in the art to understand the disclosed subject matter and implement the present invention accordingly. The embodiments, however, are not intended to restrict the scope of the present invention. Hence, all equivalent modifications and variations made in the foregoing embodiments without departing from the spirit and principle of the present invention should fall within the scope of the appended claims.

What is claimed is:

1. A light-emitting diode (LED) light source assembly with a heat dissipation base, the LED light source assembly comprising:
the heat dissipation base having a groove, the groove having a bottom surface, a first lateral surface, and a second lateral surface, wherein the first lateral surface and the second lateral surface are formed respectively with corresponding retaining recesses; and
a light bar comprising:
a flexible printed circuit (FPC) board provided on the bottom surface, the FPC board having two side portions lodged in the retaining recesses, respectively, so as to secure the FPC board in position; and
at least one LED unit provided on the FPC board and electrically connected to the FPC board;
wherein the retaining recesses correspond in shape to the two side portions of the FPC board so as to lodge the two side portions and secure the FPC board in position.

2. The LED light source assembly of claim 1, wherein the heat dissipation base is a base made of a metal with a high heat-dissipation coefficient.

3. The LED light source assembly of claim 1, wherein the heat dissipation base is made of aluminum, copper, iron, stainless steel, or a composite metal with a layered structure

4. The LED light source assembly of claim 1, wherein the bottom surface is provided with a thermally conductive insulation layer.

5. The LED light source assembly of claim 4, wherein the thermally conductive insulation layer is a ceramic insulation layer or an aluminum nitride insulation layer.

6. The LED light source assembly of claim 1, wherein each said retaining recess has an upper edge portion formed with a projecting retaining tip.

7. The LED light source assembly of claim 1, wherein each said retaining recess has:
a first surface located at an upper edge portion of the each said retaining recess so as to define an acute included angle with the first lateral surface or the second lateral surface, thereby forming a retaining tip;
a second surface adjoining the first surface and being parallel to the first lateral surface or the second lateral surface; and
a third surface located at a lower edge portion of the each said retaining recess and adjoining the second surface and the bottom surface.

8. The LED light source assembly of claim 7, wherein the third surface is a horizontal surface or an inclined surface.

9. The LED light source assembly of claim 1, wherein each said retaining recess is a horizontal recess or an inclined recess.

10. The LED light source assembly of claim 1, wherein the bottom surface is a planar surface, a concave surface, a convex surface, or a multi-sectional surface.

11. The LED light source assembly of claim 1, wherein the FPC board has a surface coated with a white reflective ink or a highly reflective ink.

12. The LED light source assembly of claim 1, wherein a heat dissipation pad or a heat dissipation gel is provided between the FPC board and the bottom surface.

13. The LED light source assembly of claim 1, further comprising heat dissipation fins or a heat conduction pipe thermally conductively connected to the heat dissipation base.

14. The LED light source assembly of claim 1, wherein the heat dissipation base is so shaped as to include heat dissipation fins.
